(19) United States
(12) Patent Application Publication
(10) Pub. No.: US 2012/0167598 A1
(43) Pub. Date: Jul. 5, 2012

(54) VACUUM ISOLATED MULTI-WELL ZERO LOSS HELIUM DEWAR

(75) Inventors: Jost Diederichs, Poway, CA (US); Michael Bancroft Simmonds, Bozeman, MT (US)

(73) Assignee: QUANTUM DESIGN, INC., San Diego, CA (US)

(21) Appl. No.: 13/244,684

(22) Filed: Sep. 25, 2011

Related U.S. Application Data
(63) Continuation of application No. 12/882,079, filed on Sep. 14, 2010, now abandoned.

(51) Int. Cl. F17C 7/02; F17C 13/02; F25B 9/00

(52) U.S. Cl. 62/6; 62/50.1; 62/49.1

(57) ABSTRACT

A multi-well helium Dewar is provided for recirculating coolant about a cryostat probe; the Dewar includes a first well containing a first coolant reservoir, and a second well containing a second coolant reservoir. A fluid connection extends between the first and second coolant reservoirs. A low impedance conduit further connects a top end of the second well to the first well. In this regard, the Dewar at least partially contains a cryocooler within the first well and a cryostat probe within the second well. Vibrational noise is reduced by the incorporation of soft mounting components for connecting various features. A thermal shield of the Dewar can be thermally connected to isolated components for additional cooling power and increased efficiency during initialization. A second fluid connection may include a valve attached to a counter-flow heat exchanger for efficiently re-condensing excess gas within the Dewar.

### CROSS-REFERENCE TO RELATED APPLICATIONS

This application is a continuation of U.S. Ser. No. 12/882,079, filed Sep. 14, 2010; the entire contents of which are hereby incorporated by reference.

### FIELD OF THE INVENTION

The present invention relates to Dewars for thermally insulating a cryostat and related components; and more particularly to helium gas Dewars for providing an insulated liquid or gaseous Helium environment for cryostats adapted to control the temperature of a region or sample. Other uses include mounting of superconducting devices such as magnets in said Dewars.

### BACKGROUND OF THE INVENTION

Cryogenic helium flow cryostats have been used for many years to regulate temperature in systems designed to test the physical properties of laboratory specimens. The need for testing physical specimens has increased substantially over the last several years. These systems are designed to characterize the physical properties of various materials under variable measurement conditions. Furthermore, these systems are capable of being programmed for an arbitrary sequence of temperature, magnetic field sweeps, and steps at which to characterize various physical properties of the sample specimen.

It is often necessary to control the temperature of these specimens precisely over a wide range of temperature from liquid helium temperatures to well above room temperature. The instruments used for characterization often contain a number of massive components, including superconducting magnets and other cryogenic components, which, because of their mass are prohibitively time-consuming to cool-down and warm-up, or require being maintained cold in order to function. In this case, it is necessary to cycle the temperature of only the specimen or a relatively small portion of the cryostat surrounding the specimen, while the other cryogenic components, such as the superconducting magnet, are maintained at an operational cold state.

A traditional method for operating a cryostat includes mounting the cryostat probe within a liquid Helium Dewar. The Helium Dewar is essentially a thermos bottle containing liquid Helium and includes a thermal shield consisting of an inner shell nested within an outer shell wherein an area between the inner and outer shells is substantially evacuated of air to create a near-vacuum. One problem with the traditional system is that the contained liquefied helium will eventually require replenishment as the liquefied helium boils off.

More recently, other methods have evolved, including gas flow cryostats that draw cold gas from an external liquid Helium reservoir, or temperature control devices that operate without Helium entirely but use the cooling power of a cryocooler.

Two major problems associated with operating liquid Helium Dewars are first, the handling of liquid Helium, i.e. transport, storage, and transfer from storage Dewar to the cryostat Dewar, is very cumbersome, expensive, dangerous, and inevitably leads to major loss of expensive Helium gas into the atmosphere. Secondly, personnel operating the cryostat need to have liquid Helium available, which it is not in many parts of the world, and they need to be trained in the handling of liquid Helium.

The first issue is often addressed by installing a Helium gas recovery system at the site of use, often with the addition of a Helium liquefier. However, these systems are complex, expensive, and require trained personnel. Recently, this issue is also addressed by certain Dewar designs (like the Quantum Design Evercool I™ series Dewars) that provide gas recovery and liquefaction inside the Dewar itself. Still, the initial cool-down of these self condensing Dewars requires the transfer of liquid Helium.

Lately, progress has been made in constructing liquid Helium Dewars that provide built-in Helium gas recovery and liquefaction, which can be started up without transferring liquid Helium from a storage container.

While these new developments have made great advances towards conserving Helium, lowering operating costs and enabling operation in areas without liquid Helium infrastructure, there are problems associated with having a cryocooler in the proximity of a cryostat. Cryocoolers produce significant vibration and acoustical noise which interferes with sensitive measurements on the specimens in the cryostat probe. Also, during power outages, cryocoolers can present a significant heat load on the cryostat leading to rapid loss of liquid helium.

One aspect of this invention addresses these shortcomings by separating the cooler reservoir from the cryostat reservoir while maintaining both reservoirs within a common thermal shield.

The coldest possible temperatures in a gas-flow cryostat are achieved by using the vapors from boiling liquid helium as the source of refrigerated helium gas. A vacuum pump may be used to simultaneously pump on a small reservoir of liquid helium and to draw the evolving vapors over or around the specimen region in the cryostat. Because the vapors are at the same temperature as the boiling helium (typically at 1 to 4 K for the helium-4 isotope); the specimen can be cooled to near the temperature of the boiling helium.

Continuous operation is achieved by continuously filling a liquid helium evaporation reservoir with liquid at low pressure using a fluid connection or other flow restrictor. This liquid is provided by liquefying a room-temperature helium gas stream using a cryogenic refrigerator such a Pulse Tube (PT) or Gifford-McMahon (GM) cryocooler. In a recirculating design, the room-temperature helium gas comes from the exhausting helium gas flowing from the cryostat through the pumping system.

The rate at which helium gas is evaporated from the reservoir is determined by the vacuum provided by the pumping system, or fluid connection, the geometry of the connecting lines, and the heat-load on the reservoir from inflowing liquid, parasitic heat sources, and the like.

Recently, with an increase in costs associated with helium gas, energy, and other operative resources, helium gas flow cryostats have become a topic for innovative reform. Demand for smaller, more efficient and cost effective systems continue to drive improvements in gas flow cryostats and their associated Dewars.

It is therefore an object of the present invention to provide Dewars and cryostat systems capable of operation in a variety of applications with increased efficiency and integrated Helium gas liquefaction and recovery. These systems will require improved helium gas recirculation and efficiency with improved thermal insulation of system components. Furthermore, these systems will require reduced helium gas input requirements such that operational costs can be minimized. In certain embodiments, these systems will provide smaller form for providing bench-top applications.

### SUMMARY OF THE INVENTION

Certain embodiments of the invention are disclosed in the following description and drawings, wherein a Dewar system is provided for containing a cryostat and a cryocooler. The Dewar generally includes a first inner shell nested within a second outer shell, wherein a volume between the first and second shells is hermetically sealed and substantially evacuated of air for providing thermal insulation to an isolated region contained within the Dewar. The Dewar further includes a first well contained within the isolated region; the first well is adapted to receive a cryocooler or similar Helium liquefaction component, and contains a first reservoir for collecting an amount of liquefied helium coolant from the liquefaction component. The Dewar further includes a second well contained within the isolated region; the second well is adapted to receive a cryostat probe or other probe requiring a liquid or gaseous helium environment for measuring a sample, and contains a second reservoir for receiving an amount of liquefied helium coolant from the first reservoir of the first well. The second reservoir is connected to the first reservoir by a fluid connection; the fluid connection is adapted to provide a constant flow of liquefied helium coolant from the first reservoir to the second reservoir for replenishing coolant in the second reservoir as liquid boils off. The second well is further connected to the first well by one of a pump, or low impedance conduit, such that the second reservoir is adapted to boil off liquefied helium into a gas-phase coolant, the gas-phase coolant flowing about the cryostat probe and collecting near the top portion of the second well before flowing into the first well by one of a pump or low impedance conduit where the gaseous helium is then re-liquefied and recycled.

For purposes of this invention, the term “cold end” may be used herein to describe the first well wherein liquefied or cold coolant is compressed by a cryocooler and collected by the first cold reservoir. The liquefied coolant being relatively colder than gas-phase coolant, thus the liquid end is the cold end of the Dewar system.

Similarly, and for purposes of this invention, the term “warm end” may be used herein to describe the second well wherein gaseous or warm coolant is boiled off from the second warm reservoir. The gas-phase coolant being relatively warmer than liquefied coolant, thus the gas end is the warm end of the Dewar system.

In one embodiment, the first reservoir is positioned at a height above the second reservoir, and is connected to the second reservoir by a fluid connection having a predetermined inner diameter adapted to provide a constant flow of liquefied coolant therebetween. The tube may include one or more restriction elements, or elements adapted to restrict the flow of liquefied coolant between the first and second reservoirs.

Liquefied coolant collects in the first reservoir contained within the first well, the liquefied coolant then travels through the fluid connection to the second reservoir contained in the second well. Once disposed in the second reservoir, the liquefied coolant is evaporated into a gas phase and flows upwardly through the cryostat chamber such that a specimen may be cooled by the flow of gas phase coolant. Upon reaching the top portion of the second well, the gas is directed back to the cryocooler by a low impedance conduit, or alternatively using a pump system. The cryocooler, or liquefaction component, then condenses the gas to a liquid phase and the liquefied coolant collects in the first reservoir. The recycled gaseous and liquefied coolant provides an efficient means for cooling the sample specimen.

As referenced above, one major problem with locating a cryocooler near a cryostat well includes vibrational noise transfer, the noise significantly impacts sensitive measurements of samples within the cryostat or sample region. Traditionally, cryocoolers have been separated from the cryostat such that these restrictions are minimized; however, this invention provides solutions to the longstanding problems associated with noise generated by a cryocooler. Specifically, one or more embodiments of the invention provide a Dewar adapted for thermally insulating at least a portion of a cryocooler and an adjacent cryostat. In these embodiments, a reduced volume is provided such that bench top applications have been made possible; whereas such bench-top applications providing a single Dewar containing a cryostat and a cryocooler have never before been suggested due to problems with noise, among others.

In certain embodiments of the invention, and to reduce vibrational noise produced by the cryocooler, the cryocooler can be mounted to the first well of the Dewar using soft mounting components such as springs, pliable mounts or spacers, or the like. Optionally, the first reservoir can be mounted to the first well of the Dewar using soft mounting components, tubings, bellows, or similar soft components. In this regard, vibrational noise can be dampened and substantially contained within the first well of the Dewar, such that sensitive measurements of the specimen may be achieved within the second well.

In another embodiment of the invention, the fluid connection, or tubing connecting the first and second reservoirs can be adapted to reduce vibrational noise from the first well and contained cryocooler. It has been determined that corrugated tubing naturally dampens the effect of noise traveling from the first well and contained cryocooler to the second well where sensitive measurements are taken. Another method of reducing noise includes providing a muffler in the fluid line.

In another embodiment of the invention, one or more of the thermal shield, first well, and second well may be wrapped in Mylar sheets for further insulating individual components. In this regard, the Mylar acts to reflect heat away from insulated sources.

It is important to recognize that both the first and second wells are substantially contained within a pair of nested shells, i.e. isolated region of the Dewar. The space between the nested shells is substantially evacuated of air to create a near vacuum for thermally isolating the cryocooler and cryostat wells. It is thermo-isolation of the contained wells that enhances thermo-stability and cooling efficiency within the cryostat system. Furthermore, by containing both a cryostat and well for at least partially receiving a cryocooler within a common Dewar, smaller volumes are required which result in improved cooling efficiency and smaller equipment size, leading to bench-top applications.

While the embodiments disclosed herein describe a Dewar system using specifically the helium-4 isotope as the coolant, one could substitute other two-phase coolants, such as helium-3, nitrogen, hydrogen, argon, as well as commercial refrigerants.

### BRIEF DESCRIPTION OF THE DRAWINGS

These and other attributes of the invention are further described in the following detailed description of the invention, particularly when reviewed in conjunction with the drawings, wherein:

FIG. 1 illustrates a cross section of a Dewar system according to one embodiment of the invention wherein the Dewar includes a pair of nested thermal insulating shells, a cryostat probe, and a cryocooler for recycling coolant within the Dewar system.

FIG. 2 illustrates a side view of the Dewar system of FIG. 1.

FIG. 3 illustrates a cross section of a Dewar system according to one embodiment of the invention wherein the Dewar includes a pair of nested thermal insulating shells, the cryocooler and cryostat probe are omitted.

FIG. 4 illustrates a side view of the Dewar system of FIG. 3.

FIG. 5 illustrates a cryocooler for use with the Dewar system.

FIG. 6 illustrates a perspective view of a cryostat probe according to at least one embodiment of the invention.

FIG. 7 is an enlarged cross sectional view of the Dewar system according to a preferred embodiment of the invention.

FIG. 8 illustrates a cross section of a Dewar system having a first well for receiving a cryocooler and a second well for receiving a sample probe, wherein the first and second wells are connected by a first fluid connection and a second fluid connection.

FIG. 9(a-b) illustrate a cross sectional view of a Dewar system having a first well for receiving a cryocooler and a second well for receiving a sample probe, wherein the first and second wells are connected by a counter-flow heat exchanger.

### DETAILED DESCRIPTION

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention. Certain embodiments will be described below with reference to the drawings wherein illustrative features are denoted by reference numerals.

In a general embodiment of the invention, a Dewar system is provided for containing a cryocooler and a cryostat, wherein a coolant is continually recycled within the Dewar from a gas-phase to a liquid phase. The Dewar system generally includes an inner shell nested within an outer shell, wherein an area between the inner and outer shells is hermetically sealed and substantially evacuated of air to form a vacuum insulated thermal shield having an isolated region contained therein. The shells may be hermetically sealed about the top plate, second plate, first well or second well. Within the isolated region, the Dewar includes a first well and a second well for containing a cryocooler and a cryostat probe, respectively. The first and second wells each include a liquid coolant reservoir disposed near the bottom of the respective wells. The liquid coolant reservoirs are connected by a fluid connection extending from the first reservoir to the second reservoir.

The purpose of the first coolant reservoir contained within the first well is to collect and store an amount of liquefied coolant as that coolant is condensed by the cryocooler. In contrast, the purpose of the second reservoir contained in the second well is to receive liquefied coolant from the first reservoir through the fluid connection, and to boil off gas-phase coolant as the liquefied coolant increases in temperature toward its inherent boiling point. The gas-phase coolant, although relatively warm when compared to its liquid-phase counterpart, remains cold enough to cool a specimen sample as the gas rises toward an upper portion of the second well.

The fluid connection may include a tubing or channel for connecting the first reservoir to the second reservoir. Optionally, the fluid connection may include a restriction for creating an additional cooling source when used in conjunction with a pump or blower at the warm end; in this regard the restriction acts as a Joule-Thompson valve. The fluid connection may be adapted as a corrugated tubing. In certain embodiments, corrugated tubing has been shown to reduce transfer of vibrational noise from the cryocooler to the second well where sensitive measurements are taken. Alternatively, it has been recognized that noise from the cryocooler and first reservoir may be dampened with the incorporation of a muffler in the fluid line. In this regard, sensitivity can be improved using corrugated tubing, or a muffler disposed in the fluid line.

The coolant can be recycled within the Dewar system as the gas-phase coolant collects near the top portion of the second well, and is transferred or fed back into the first well where the contained cryocooler compresses and re-liquefies the gas-phase coolant into a liquid-phase for collecting in the first reservoir. In this regard, the coolant can be recycled within the isolated region of the Dewar system, thereby significantly reducing or eliminating loss of coolant, and eliminating a need for replenishment of a liquefied coolant into the system.

In one embodiment, the gas-phase coolant can be forced into the first well by a pump system. The pump system can be contained within the isolated region, or externally therewith. The pump can be switched on and off as required to maintain a balance of coolant between the first and second reservoirs, for example if the first reservoir is filled with coolant to a predetermined point, the pump may shut off temporarily to allow the liquefied coolant to flow into the second reservoir for boiling-off. This may be of particular benefit for preventing the overfilling of the first liquid coolant reservoir, which may damage the cryocooler.

In another embodiment, the gas-phase coolant can be transferred to the first well by a low impedance conduit. The low impedance conduit may have an internal diameter sufficient to promote natural convection between the second well and first well, respectively. The low impedance conduit may include a tubing or channel connecting a top portion of the second well to the first well and contained cryocooler.

In another embodiment of the invention, and where a reduction in noise is of particular interest, the cryocooler may be configured within the first well by suspension or attachment using any of a group of soft mounting components. The soft mounting components may include springs, pliable mounts or spacers, rubber or soft fittings, or the like. For example, the cryocooler may be suspended within the first well by a number of springs and soft fittings. By suspending the cryocooler within the first well, vibrational noise can be significantly contained in the first well and transmission of the noise between the wells through the Dewar or through the one or more fluid connections can be reduced accordingly.

Similarly, the first reservoir can be mounted to the first well of the Dewar using soft mounting components, tubings, corrugated tubings, bellows, or similar soft components. In this regard, vibrational noise can be dampened such that sensitive measurements of the specimen may be achieved. In one embodiment, the first reservoir is attached to the first well by a soft tubing, or coupler; vibrational noise from the cryocooler is therefore dampened by the soft coupler and significantly reduced at the first reservoir. With reduced vibrational noise at the first reservoir, there is less noise for transmittance to the second reservoir through the fluid connection, and hence the sensitivity of measurements may be significantly improved. Similarly, the second reservoir can be connected to the second well using one or more soft mounting components.

In yet another embodiment of the invention, Mylar or similar reflective sheets may be applied to an exterior surface of the Dewar's outer shell. Aluminum or gold coated Mylar sheets work to reflect heat away from insulated components. For example, the Dewar can be wrapped with Mylar sheets for reflecting heat away from the isolated region.

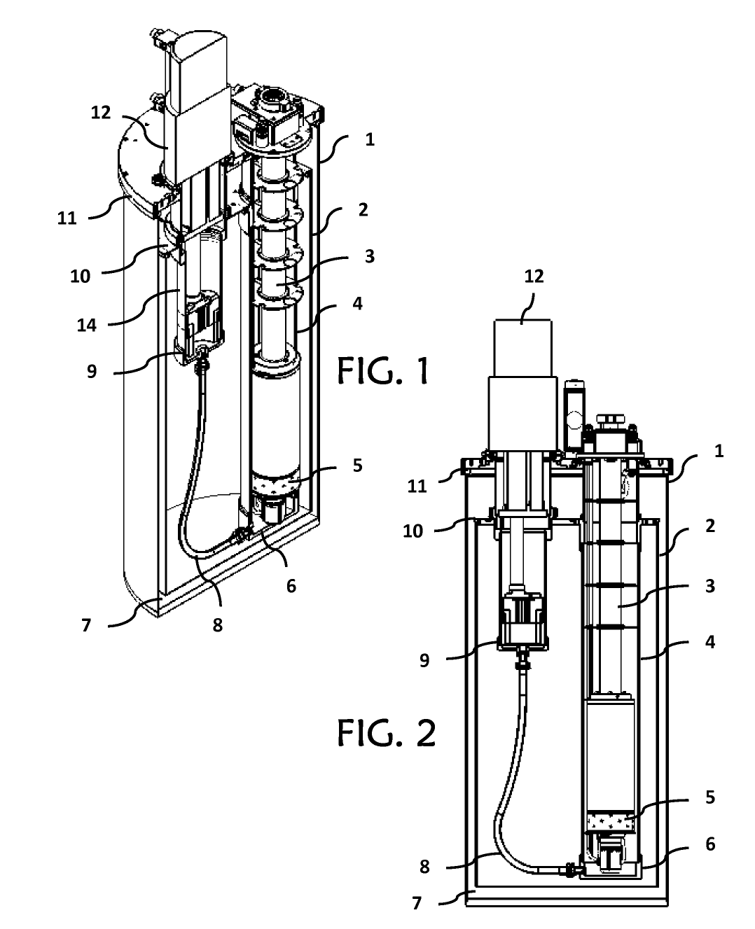

Now turning to the figures, an exemplary embodiment of this invention is illustrated in FIGS. 1-2, wherein a Dewar system comprises: a first well 14 for at least partially receiving a cryocooler 12 capable of cooling or condensing a coolant gas, and more particularly helium gas; a first reservoir 9 for collecting and containing an amount of liquefied coolant, the first reservoir 9 being substantially disposed within or near the first well 14; a second well 4 for receiving a cryostat probe 3; a second reservoir 6 for receiving and containing an amount of liquefied coolant, the second reservoir 6 being substantially disposed within or near the second well 4; a high conductivity thermal shield 2 (also herein referred to as a first shell) substantially captivating the first and second wells 14, 4; and an outer shell 1 surrounding the high conductivity thermal shield 2, wherein the volume of space 7 between the outer shell and the high conductivity thermal shield is evacuated almost entirely of air, the near vacuum therein minimizing conduction and convection of heat.

The first well 14 extends substantially vertically from the first liquefied coolant reservoir 9 to a first upper rim 16. The second well 4 extends substantially vertically from the second liquefied coolant reservoir 6 to a second upper rim 17.

The first reservoir 9 of the first well 14 is positioned at a height above the second reservoir 6 of the second well 4, and connected thereto by a fluid connection 8, such as a capillary tubing or similar component, placing the second coolant reservoir in fluid communication with the first coolant reservoir. The fluid connection 8 preferably comprises an inner diameter adapted for promoting a constant flow of liquefied coolant. The fluid connection may be adapted for low impedance, and therefore optimized flow of liquefied coolant. The fluid connection may further include a restriction element such as a Joule-Thompson valve or mechanical valve for restricting the flow of liquefied coolant from the first reservoir to the second reservoir. At least a portion of the fluid connection 8 may further include an inner diameter adapted to restrict the flow of liquefied coolant, and therefore the fluid connection itself may in certain embodiments act as a restriction element.

The first well is adapted to at least partially receive a cryocooler 12, such as a Pulse Tube (PT) or Gifford-McMahon (GM) cryocooler. The function of the cryocooler is to receive gas-phase coolant and cool or compress the gas into a liquefied coolant. A top plate 11 may include a first aperture for receiving a portion of the cryocooler 12, and a second aperture for receiving a specimen probe 3. The first aperture is adapted to be disposed near the top end of the first well. In alternate embodiments (not illustrated), the top plate can comprise a single aperture for providing access to an adjacent well.

The second well 4 at least partially contains the second reservoir 6, and is adapted to at least partially receive a specimen probe 3. The second reservoir 6 is positioned near the bottom of the second well 4. As liquefied coolant evaporates from the second reservoir 4, the evaporated gas phase coolant flows upwardly about the specimen region thereby cooling the specimen sample or samples. Upon reaching the top portion of the second well, the gas phase coolant is returned to the cryocooler 12 and first well by way of a low impedance conduit, or a pump system (not shown).

The pump system can further incorporate a ball gauge or similar visual gauge for providing visual confirmation of gas flow rate from the second well to the cryocooler at the first well.

In sum, the coolant cycles from the first reservoir within the first well in liquid form, flows through the fluid connection connecting the first reservoir to the second reservoir, evaporates from the second reservoir to flow about the cryostat region and is directed to the condenser by one of a low impedance conduit, or a pump system, where the condenser liquefies the coolant for collection within the first reservoir. A substantial portion of the cryostat components are contained within the isolated region of the Dewar, this provides greater efficiency and longevity of coolant between recharge. A recirculating or recycling helium gas flow cryostat can operate for several months without a need for recharge. However, in certain circumstances a minimal coolant recharge can be facilitated by the input of additional liquefied coolant.

The high conductivity thermal shield is fabricated from a thermally conductive material, such as aluminum. The thermal shield functions to isolate the cryostat from heat convection from the environment outside of the cryostat. The thermal shield may further be wrapped with aluminum or gold coated Mylar insulation sheets to further insulate the internal components of the cryostat. The thermal shield substantially captivates or surrounds the first and second wells, protecting the internal contents from radiation of external heat sources. A first or outer shell substantially surrounds or captivates the thermal shield, and the first and second shells are hermetically sealed to form a volume therebetween. The air between the first and second shells also referred to herein as a vacuum region, is substantially evacuated to create a near vacuum for further insulation. Because there is little to no air in the vacuum region, there are less molecules and therefore reduced convection from the external environment to the cryostat components.

One or more superconducting components, such as a superconducting magnet or similar components may further be contained within the multi-well Dewar.

In another embodiment, the Dewar system includes a pump connecting the warm end (gas phase) to the first well and contained cryocooler, the pump pressurizes the liquefied coolant within first well such that the flow of liquefied coolant through the fluid connection establishes forced convection through the restriction, the restriction thereby behaving as an additional cooling source.

In another embodiment, a plurality of fluid connections may extend between the first and second wells. Optionally, the plurality of fluid connections may be placed at various heights within the first and second wells, such that as the level of liquefied coolant increases within the first reservoir additional capillaries become active in transferring the flow of coolant to the second reservoir such as to prevent overfilling of the first reservoir. Alternatively, the additional fluid connections may extend between the first and second wells to facilitate convection of gas-phase coolant for additional cooling capabilities. One or more of the plurality of fluid connections can be adapted to reduce vibrational noise. It should be further understood that the one or more fluid connections may be adapted to receive liquid-phase coolant, gas-phase coolant, or a combination thereof.

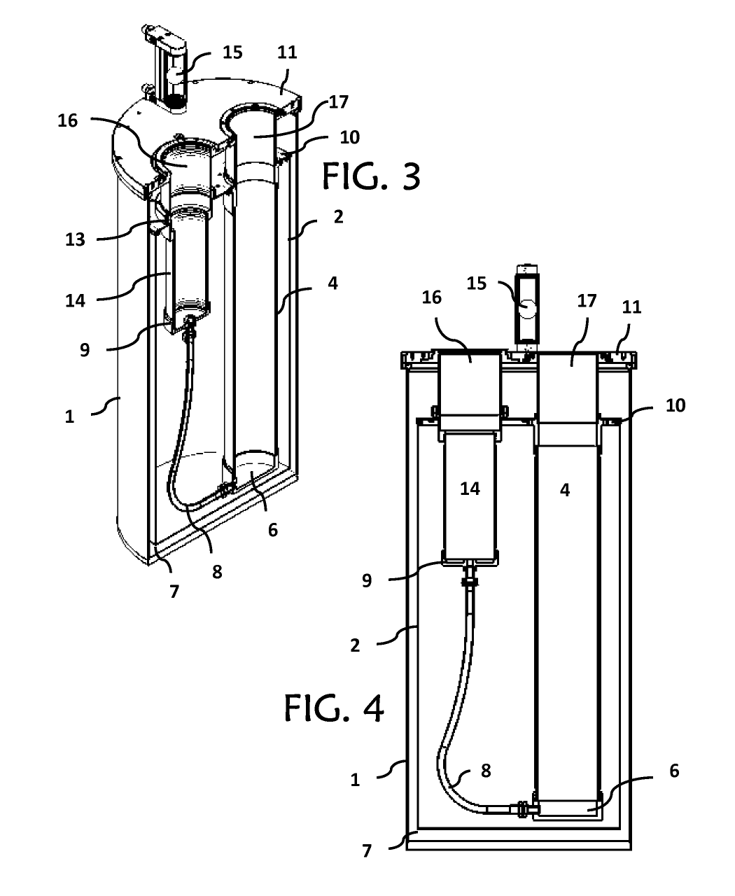

FIGS. 3-4 further illustrate the cryostat system of FIGS. 1-2 with the cryocooler and specimen probe omitted such that a clear view of the thermal shield and other operative components may become apparent to one having skill in the art. The cryostat system includes: a first well 14 adapted to receive a cryocooler; a second well 4 adapted to receive a specimen probe; the first well 14 further comprises a first reservoir 9 positioned near the bottom of the first well; the second well 4 further comprises a second reservoir 6 positioned near the bottom of the second well; the first reservoir 9 is disposed at a height above the second reservoir 6 within the cryostat and is connected to the second reservoir 6 by a fluid connection 8. The cryostat system further includes: a thermal shield 2 substantially surrounding the first and second wells 14; 4, and an outer shell 1 substantially surrounding the thermal shield 2. The area between the thermal shield 2 and the outer shell 1 defines a sealed vacuum region 7, wherein a substantial amount of air is evacuated from the region.

The Dewar further includes a second plate 10 comprising a first aperture extending to the first well 14, and a second aperture extending to the second well 4. One or more soft mounting components can be arranged at said apertures to enable reduced vibrational noise of the cryocooler, specimen probe, first reservoir, or second reservoir.

Similar to above, the Dewar further includes a top plate 11 comprising a first aperture and a second aperture. The first and second apertures may further include one or more soft mounting components for connecting any of a cryocooler, specimen probe, or reservoir to the respective well such that vibrational noise is minimized within the cryostat system. A ball gauge 15 or other gas flow gauge may be further connected to the top plate of the outer shell.

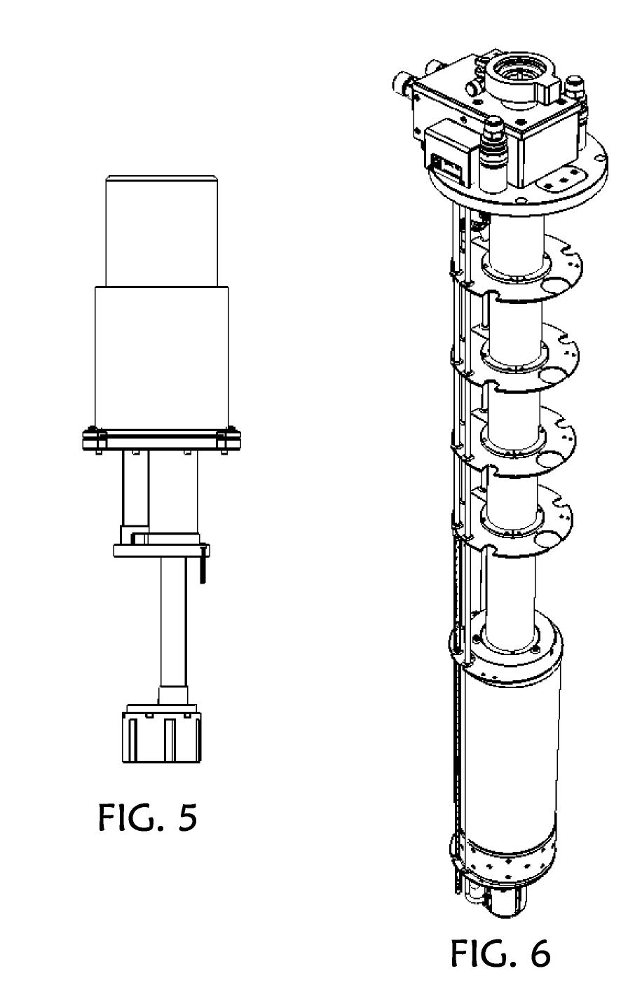

FIG. 5 illustrates a cryocooler as may be incorporated into certain embodiments of the invention. The cryocooler functions to condense or cool gas phase coolant into a liquid phase. Examples of compatible cryocoolers include: Gifford-MacMahon coolers; Joule Thomson coolers; and Pulse tube refrigerators.

FIG. 6 illustrates a cryostat probe according to one embodiment of the invention. The purpose of the cryostat probe is to secure one or more samples within a specimen region of the cryostat probe, the cryostat probe is placed inside the second well for receving a flow of gas-phase coolant to vary the temperature of the one or more samples during measurement.

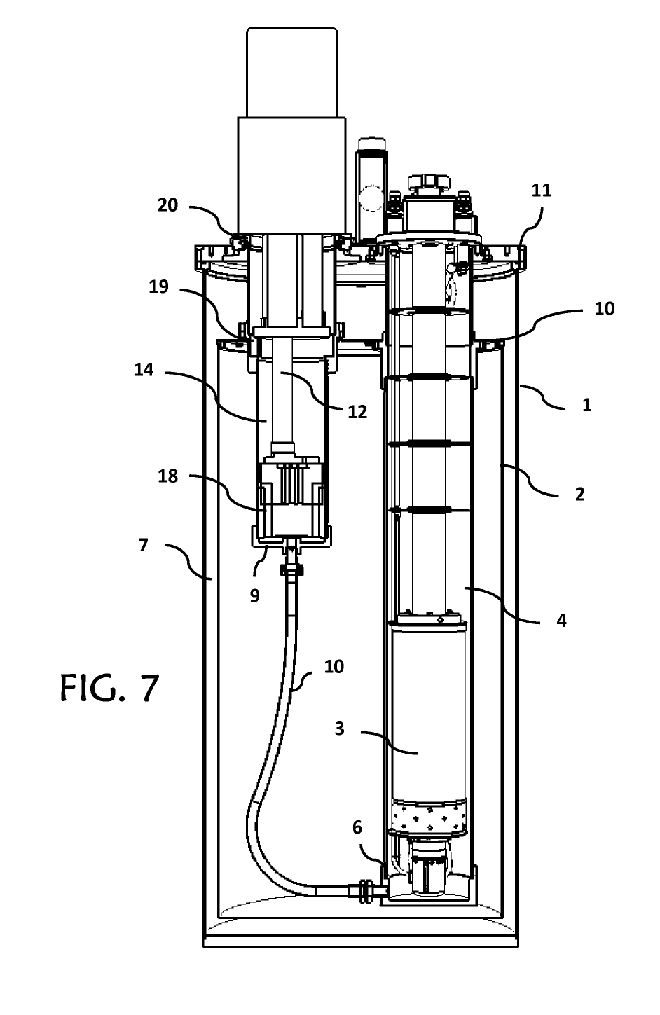

FIG. 7 illustrates a cryostat system according to a preferred embodiment of the invention, wherein a first reservoir 9 is connected to a second reservoir 6 by a low impedance fluid connection 10; the first reservoir 9 is adapted to receive and contain condensing coolant from a cryocooler 12; the second reservoir 6 receives liquefied coolant transferred through the fluid connection 10 from the first reservoir 9, the second reservoir 6 may also be referred to as an evaporation reservoir due to the function of the evaporation reservoir being the evaporation of liquefied coolant into a gas-phase coolant for flowing about a specimen region of a cryostat probe 3. Both the first and second reservoirs are contained within the isolated region of the Dewar. Soft mounting components, such as springs 20, soft spacers 19, and bellows 18 are used to suspend the cryocooler 12 within the first well.

In another embodiment of the invention, excess cold gas is re-condensed for increased efficiency of the multi-well Dewar system. Cryostat inserts (also referred to herein as “cryostat probes”) have various mechanisms that consume Helium gas, in other words, cause liquid Helium to boil or Helium gas to be transferred out of the Dewar region. This gas is then recycled back into the Dewar by letting it condense in the cooler well as described above. We put these loss mechanisms in two categories.

First, we consider solid conduction heat loads. Some of these mechanisms are heat sources that can be intercepted by cold Helium gas moving up inside or around the cryostat probe. The top of the cryostat is usually warm (near room temperature) and the bottom immersed in the cold Helium (gas or liquid). This leads to thermal conduction of heat down the solid parts of the cryostat probe by diffusion. In practice, this thermal diffusion presents a significant heat load on liquid Helium and its rapid boil-off, if not addressed. However, gas that is generated naturally by boiling Helium, can be used to effectively intercept solid conduction heat loads. If the cryostat probe is designed to transfer conduction heat to the Helium gas that is moving up the probe, the conduction heat is thus intercepted and does not reach the Helium liquid. This design approach is referred to as “Helium vapor cooled cryostat”. The Dewar described in this invention takes advantage of vapor cooled cryostat designs as a positive gas flow up the probe well and down the cooler well is always maintained—either by natural convection or forced flow.

The second category of mechanism that causes Helium to boil includes heat sources that cannot be intercepted by vapor cooling. These are commonly components of the cryostat that are immersed in the liquid and generate heat. These include superconducting magnets, light sources, heaters associated with sample temperature control, electric circuits, and others. Superconducting magnets are notorious for generating large amounts of heat when they are charged or discharged. Amounts of Helium gas are boiled off in excess of that needed for vapor cooling. This excessive amount of gas has to travel up the probe well (all the way to the top) to be re-condensed in the cooler well, during which process it warms up all the way to room temperature. This mode is in-efficient.

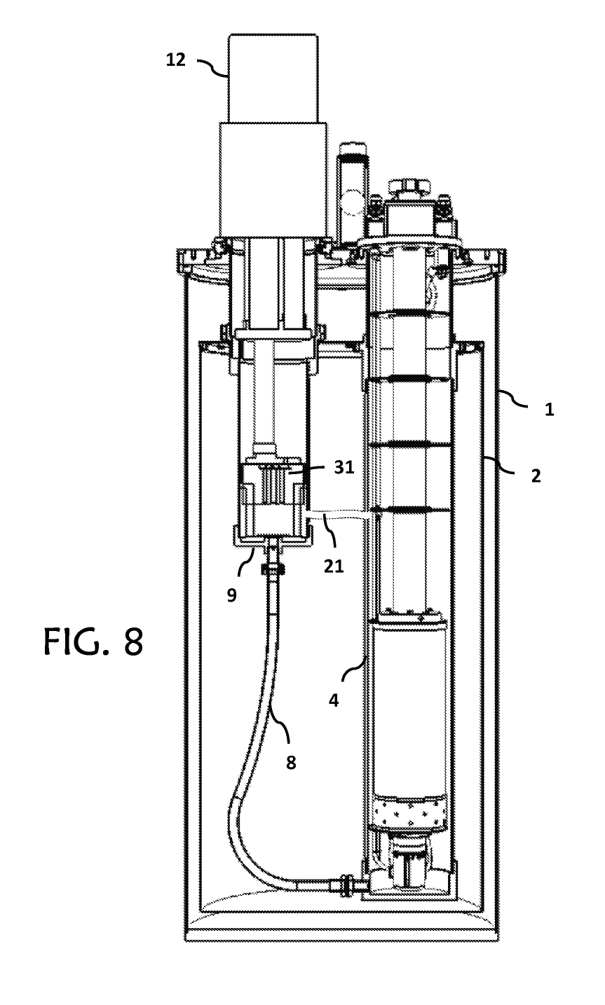

In order to maximize the efficiency of a dual well Dewar one can add a shortcut for the excess cold gas in the following way. The simplest approach, as illustrated in FIG. 8, includes adding a second fluid connection 21 between the first and second wells. The second fluid connection tube 21 has a first end that connects to the cooler well near the condenser 31 of the cryocooler, and, on the other end, connects to the probe (cryostat) well 4 at a position just above the normal liquid level. This way, the condenser can re-condense cold gas without the gas having to take the inefficient travel up and down both wells.

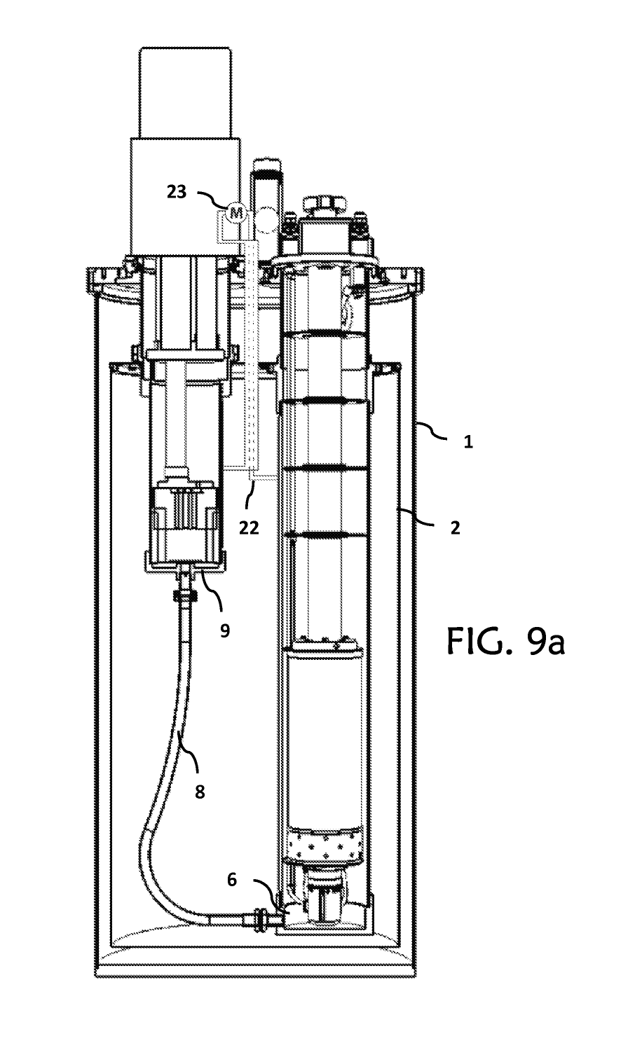

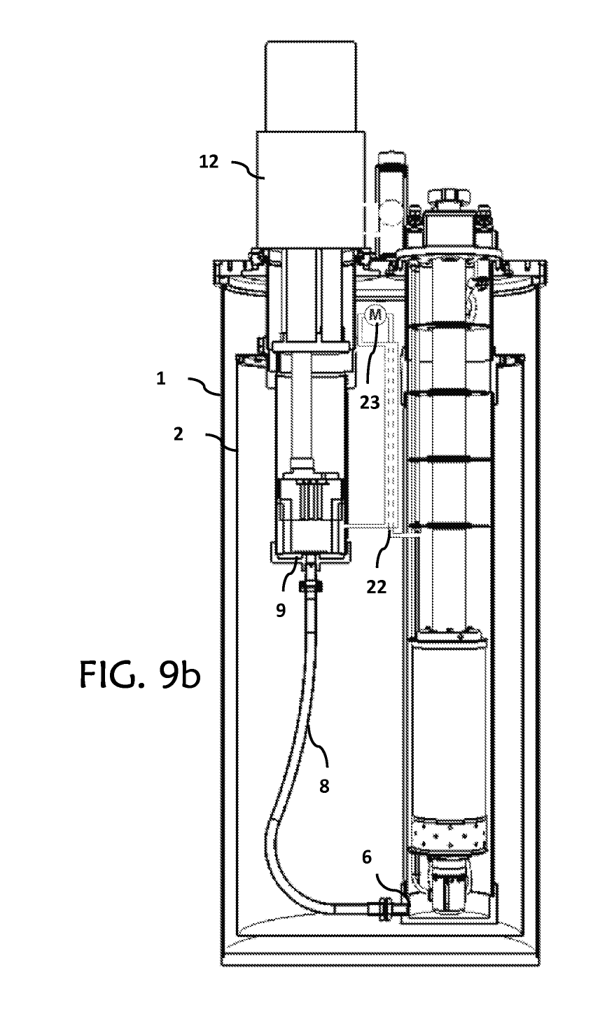

A second approach, as illustrated in FIGS. 9(a-b), includes the addition of a restriction or valve 23 to the second fluid connection tube 22, to assure that some of the boil-off is still moving up the probe well and maintains vapor cooling of the probe, the importance of which was outlined above. Since the boil-off cause by superconducting magnets and such may be sporadic, one might use automatically adjustable valve. Since the mechanics of valves that operate at liquid Helium temperatures are difficult, one can mount the valve outside the Dewar, as illustrated in FIG. 9a, and connect it to the shortcut tube with a counter-flow heat exchanger 22, of which, there are very efficient designs. Alternatively, certain designs may include a restriction or valve 23 capable of operation under cold temperatures; the valve can be connected to a counter-flow heat exchanger for containment within the isolated region of the Dewar, as is illustrated in FIG. 9b.

A third approach is to mount the shortcut tube without restriction while ensuring the vapor cooling of the cryostat by connecting a pump at the warm end of the probe well, that ensures a positive flow of gas up the probe well and feeds it back into the cooler well.

In another embodiment of the invention, initial cool-down and cooling efficiency of the Dewar system can be improved by communicating cooling power from the cryocooler to the thermal shield. The thermal shield is normally mechanically anchored to the probe well at a distance far enough below the top plate of the Dewar that the thermal conduction heat load originating at the top plate is reasonably small (usually in the order of 1 watt). A good temperature for a thermal radiation shield is typically 40 K to 90 K so that its black body radiation transfer to the liquid Helium areas within is reasonably small (typically around 50 mWatt). In order to maintain the thermal radiation shield at said temperatures it needs to be actively cooled. In the two-well Dewar system, two cooling sources can be utilized. One is the vapor cooling provided by evaporating Helium gas travelling up the probe well, to which the shield is mechanically anchored (and thus also thermally), and the other source is thermally conductive straps that connect the shield to the cooler well at a suitable position. Two stage cryocoolers typically have a first stage that runs at temperatures between 35 K and 70 K with enough cooling power to service the cooling needs of the shield. These straps are particularly useful during the cool-down phase of the Dewar where there is no vapor cooling in effect until liquid is collected and liquid cannot be collected before the thermal shield is cold. Thus, the cooling power of the cryocooler can be utilized for cooling down the thermal shield upon initialization of the Dewar system.

While exemplary and alternative embodiments of the invention have been presented in detail above, it should be recognized that numerous variations may exist. It should also be appreciated that the described embodiments are only examples, and are not intended to limit the scope, configuration, or applicability of the described invention in any way. It should be understood that various changes can be made in the function and arrangement of elements without departing from the scope as set forth in the appended claims and the legal equivalents thereof.

What is claimed is:

1. An apparatus, comprising:
a first well extending substantially vertically from a first liquefied coolant reservoir to a first upper rim and adapted to at least partially receive a cryocooler for condensing gas-phase coolant;
a second well extending substantially vertically from a second liquefied coolant reservoir to a second upper rim and adapted to at least partially receive a specimen probe;
said second liquefied coolant reservoir adapted for fluid communication with said first liquefied coolant reservoir at a fluid connection extending therebetween;
a low impedance conduit connected between a top portion of said second well and said first well; and
a pair of nested shells substantially surrounding said first and second wells, said nested shells being hermetically sealed to form a volume therebetween;
wherein said volume between the nested shells is substantially evacuated of air.

2. The apparatus of claim 1, further comprising a pump for providing forced convection of said gas-phase coolant between said top portion of said second well and said first well.

3. The apparatus of claim 1, further comprising a superconducting magnet.

4. The apparatus of claim 1, further comprising bellows for connecting a bottom portion of said first well to said first liquefied coolant reservoir.

5. The apparatus of claim 4, wherein said bellows are adapted for dampening acoustic noise.

6. The apparatus of claim 1, further comprising a top plate, said top plate including at least one aperture for providing access to an adjacent well.

7. The apparatus of claim 6, further comprising a second plate, said second plate including a first aperture for receiving a portion of said first well and a second aperture for receiving a portion of said second well.

8. The apparatus of claim 7, wherein said nested shells are hermetically sealed about at least one of said: top plate, second plate, first well, and second well.

9. The apparatus of claim 1, further comprising a ball gauge for visual representation of gas flow from said second well to said first well.

10. The apparatus of claim 1, further comprising a second fluid connection extending from said first well to said second well for providing an additional level of cooling to a sample region.

11. The apparatus of claim 10, wherein at least one of said fluid connection and said second fluid connection comprises corrugated tubing for further dampening acoustic noise.

12. An apparatus, comprising:
a first reservoir for containing a first amount of liquefied coolant;
a second reservoir for containing a second amount of liquefied coolant;
at least one fluid connection extending from said first reservoir to said second reservoir;
said first and second reservoir substantially surrounded by a thermal shield;
said thermal shield substantially surrounded by an outer shell,
wherein a space between said thermal shield and said outer shell is substantially evacuated of air to form a vacuum insulated region.

13. The apparatus of claim 12, further comprising a cryocooler for condensing coolant from a gas phase to a liquid phase.

14. The apparatus of claim 13, further comprising a pump system, said pump system adapted to receive said gas-phase coolant from said second reservoir and force said gas-phase coolant into said first well containing said cryocooler.

15. The apparatus of claim 14, wherein said first reservoir is adapted to collect condensed liquefied coolant from said cryocooler.

16. The apparatus of claim 12, further comprising a cryostat probe for regulating temperature about a specimen region contained therein.

17. The apparatus of claim 16, wherein said second reservoir is adapted to evaporate said liquefied coolant about said cryostat probe.

18. The apparatus of claim 12, wherein said liquefied coolant is one of: helium-4, helium-3, nitrogen, hydrogen, or argon.

19. The apparatus of claim 12, wherein said thermal shield further includes one or more thermal radiation barriers wrapped on a surface thereof; said thermal radiation barriers including aluminum or gold coated Mylar sheets.

20. The apparatus of claim 12, comprising two or more fluid connections, wherein each of said fluid connections extends from said first reservoir to said second reservoir.

21. (canceled)

22. (canceled)

23. (canceled)

24. (canceled)

25. (canceled)

26. (canceled)
